(19) United States
(12) Patent Application Publication
(10) Pub. No.: US 2018/0025152 A1
(43) Pub. Date: Jan. 25, 2018

(54) SECURING MULTI-TENANCY IN A DATACENTER USING NANOSERVICES

(71) Applicant: Telefonaktiebolaget LM Ericsson (publ), Stockholm (SE)

(72) Inventors: Racha BEN ALI, Fremont, CA (US); Wassim HADDAD, San Jose, CA (US); Heikki MAHKONEN, San Jose, CA (US); Ravi MANGHIRMALANI, Fremont, CA (US); Meral SHIRAZIPOUR, San Jose, CA (US)

(21) Appl. No.: 15/214,321

(22) Filed: Jul. 19, 2016

(51) Int. Cl. G06F 21/53

(52) U.S. Cl. CPC G06F 21/53; G06F 2221/034

(57) ABSTRACT

A datacenter is configured to execute a method to improve multi-tenant security by isolating container applications or nano-service applications by implementing a set of system call separation functions (SCSFs) in a set of corresponding nano-services for each container application or nano-service application. The method includes receiving a request to initiate a container application or a nano-service application, determining a set of nano-services and SCSFs to service the container application or the nano-service application, packaging the set of nano-services and SCSFs to service the container application or the nano-service application, and sending the set of nano-services and SCSFs to be instantiated by the datacenter.

### TECHNICAL FIELD

Embodiments of the invention relate to the field of datacenter operation; and more specifically, to a system and method for improving the security of data centers supporting multi-tenancy.

### BACKGROUND

Datacenter service providers, referred to as Infrastructure as a Service (IaaS), offer compute, storage and network resources to their customers by slicing physical hardware into virtualized tenant resources. Each tenant can subscribe to the datacenter services to obtain a required amount of virtualized compute, storage and network resources and utilize these resources based on their own requirements. Each tenant in the same datacenter expects isolation from other tenants even though underneath they share the same physical infrastructure. Tenant isolation is provided to the tenants through different mechanisms in the datacenter, also referred to as cloud operating systems.

Isolating compute can be done through the hypervisor that manages the central processing unit (CPU) and memory resources in a set of computing devices within the datacenter. Storage isolation can be provided by organizing physical volumes into logical volumes and granting access to these resources only to authorized tenants. Network resource isolation is a harder problem to solve as these isolated tenant networks need to reach the external networks through the same physical network interface card (NIC) and the datacenter switching infrastructure. It is easy to find security holes in the datacenter configuration by finding errors in this isolation that lead to “information leaks” between the tenant networks, to the corruption of information, or to denial of services where resource isolation enforcement is not properly configured.

Some datacenters have further offered Platform as a Service (PaaS) in addition to the more basic IaaS, where a platform including such elements as a development environment, middleware, databases and similar services are provided within the datacenter. Some PaaS vendors and customers utilize a hybrid configuration where various aspects of the services and applications utilized by each customer run in the datacenter (provider premises) while other services and application run in customer computing devices (customer premises). This hybrid approach seeks to avoid the shortcomings of traditional IaaS and PaaS solutions that cause numerous problems for PaaS customers, in particular large enterprises.

In many cases developers use PaaS to speed up the deployment or update of applications and services from development to production. However, the development and update process for these applications and services may be halted before completion because it is unclear what the impact that the new or updated applications and services will have on the security of the existing information technology infrastructure of the PaaS customers. In addition, managing multiple platforms to deploy new or updated systems, apps or features becomes cumbersome.

### SUMMARY

In one embodiment, a method is implemented by a datacenter to improve multi-tenant security by isolating container applications or nano-service applications by implementing a set of system call separation functions (SCSFs) in a set of corresponding nano-services for each container application or nano-service application. The method includes receiving a request to initiate a container application or a nano-service application; determining a set of nano-services and SCSFs to service the container application or the nano-service application, packaging the set of nano-services and SCSFs to service the container application or the nano-service application, and sending the set of nano-services and SCSFs to be instantiated by the datacenter.

In another embodiment, a datacenter is configured to execute a method to improve multi-tenant security by isolating container applications or nano-service applications by implementing a set of system call separation functions (SCSFs) in a set of corresponding nano-services for each container application or nano-service application. The datacenter includes a non-transitory computer readable medium having stored therein a SCSF manager, and a processor coupled to the non-transitory computer-readable medium. The processor configured to execute the SCSF manager. The SCSF manager is configured to receive a request to initiate a container application or a nano-service application, to determine a set of nano-services and SCSFs to service the container application or the nano-service application, to package the set of nano-services and SCSFs to service the container application or the nano-service application, and to send the set of nano-services and SCSFs to be instantiated by the datacenter.

In a further embodiment, a non-transitory computer-readable medium has stored therein a set of instructions which when executed by a computing device cause the computing device to perform a method to improve multi-tenant security by isolating container applications or nano-service applications by implementing a set of system call separation functions (SCSFs) in a set of corresponding nano-services for each container application or nano-service application. When the computing device executes the set of instructions it causes the computing device to perform the operations of receiving a request to initiate a container application or a nano-service application, determine a set of nano-services and SCSFs to service the container application or the nano-service application, packaging the set of nano-services and SCSFs to service the container application or the nano-service application, and sending the set of nano-services and SCSFs to be instantiated by a datacenter.

### BRIEF DESCRIPTION OF THE DRAWINGS

The invention may best be understood by referring to the following description and accompanying drawings that are used to illustrate embodiments of the invention. In the drawings:

FIG. 1A is a diagram of one embodiment of a datacenter configuration.

FIG. 1B is a diagram of one embodiment of a datacenter configuration with system call separation functions (SCSFs).

FIG. 2 is a diagram of one embodiment of a timing diagram of the process for deploying SCSFs.

FIG. 3 is a flowchart of one embodiment of a build time process for SCSFs

FIG. 4 is a flowchart of one embodiment of a run-time process for SCSFs.

### DETAILED DESCRIPTION

The following description sets forth embodiments of methods and apparatus for providing secure lightweight virtualized applications without incurring the overhead of running them in virtual machines (VMs). The embodiments provide a process and system for using nano-services (e.g. unikernels) to sandbox each of the system calls for each type of infrastructure as a service (IaaS) resource made by each virtualized application without requiring an operating system kernel sandboxing mechanism within a virtual machine, but rather by use of system call separation functions (SCSFs) within the physical machine kernel hypervisor. Each virtualized application's access rights are thus configured in a nano-service prior to deployment of the latter. The virtualized applications running without the need of a sandboxing mechanism within the virtual machine kernel and hence the lightweight aspect of the secure isolated sandboxing is provided using SCSF within the baremetal kernel/hypervisor. Moreover, SCSF is based on nano-services that are natively immutable, therefore the sandboxing mechanism is much more secure than regular kernel sandboxing.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Overview

Security in data centers including those provided in infrastructure as a service (IaaS) and platform as a service (PaaS) manage security via access control, encryption, tenant isolation and similar mechanisms. An IaaS or PaaS environment provides a certain level of access control support. This is achieved in datacenters through policy engine hooks being provided in every datacenter component that enforces access control of different users for the different operations on the different resources types (i.e., defining which user or application can do what to what). A basic policy language may be to express these policies usually by the administrative user.

Encryption of data can protect the data but not the functionality of the service. Some datacenters use secure hypertext transfer protocol (HTTP) for the user front end web server as well as for the HTTP application programming interfaces (APIs). Also, optionally transport layer security (TLS) is used for the messaging system bus network address translation security (NATS). Other resources' encryptions rely on underlying Infrastructure as a Service features (from OpenStack, VCloud Director/vCenter, AWS, GCE, and similar vendors or providers.)

Tenant isolation is another mechanism for providing datacenter security. Tenant isolation may require the IaaS or PaaS services be instantiated per tenant in order to achieve proper isolation. Often network protocols that guarantee separation of traffic are used. In some datacenters, tenant isolation relies on the underlying IaaS to “fully” isolate a whole data center from each tenant.

The embodiments overcome the problems with the security mechanisms available for datacenters. Currently the use of virtual machines (VMs) is necessary in order to assure security in multi-tenant datacenters. The isolation techniques of datacenters provide a good level of security but prevents tenants efficiently sharing datacenter resources and hence prevents the PaaS or IaaS provider to capture the full value of the datacenter architecture.

VMs have significant overhead. Running a VM with an operating system (OS)/monolithic kernel on top of another minimalistic OS bare-metal hypervisor provides a lot of duplicated OS functionalities that are usually not required by a datacenter application that could run directly on containers on a minimalistic OS (this is unfortunately necessary to provide a secure layer of multi-tenant isolation). These extra OS functionalities such as scheduling multiple processes within a VM hinders the performance of the application with all the context switching between CPU and input/output (IO) intensive processes scheduled independently by the uncoordinated outer kernel scheduler and the inner kernel scheduler that leads to very frequent inefficient translation lookaside buffer (TLB) flushes if not running hardware virtualized on very modern processors supporting assigning TLB per virtual path identifier (VPID) and virtual machine read/write (VMREAD/VMWRITE) instructions like the intel Nehalem architecture for instance. This is a problem specially for some critical applications that cannot tolerate non-deterministic service level agreement (SLA) performance violations.

Moreover, various software applications and packages used by a tenant may come from third party sources and open security threats within the well-guarded perimeter of the tenant's portion of the datacenter. Many applications could have very strict security requirements, for instance regarding multi-tenant isolation. For example, competing organizations are reluctant to move to the datacenter (also referred to as cloud service), because they are afraid of information/data leaks/breaches to competitors regarding their operations or secrete a sauce that secures their market share. Although a VM does not share its supposedly secure well-known monolithic kernel with other tenants' virtual machines' kernels during an attack (and it is much more isolated when using hardware virtualization), it is still running a lot of extra functionalities in the monolithic kernel that are not required for most of the specialized micro-services. This usually results in larger opportunity windows for the user VM to start an attack on the underlying hypervisor due to all the frequent VM exits to the hypervisor code that constitute most of the attack vectors consisting in either injecting malicious code in the VM run level ring or exploiting some unknown bugs in latest hypervisors (note that hypervisors are usually not 100% runtime tested/regression tested after features upgrades). Reducing that attack surface is of paramount importance for micro-services having high security requirements.

The embodiments overcome these limitations of the prior art datacenter security structures and processes. The embodiments of the invention propose to extend the datacenter platform to support nano-services for supporting nano-service based jobs (workloads) mainly for inherent multi-tenant security.

These nano-services provide a lightweight secure multi-tenancy mechanism. Lightweight secure multi-tenancy is achieved by removing the need of heavy VM overhead. The datacenter can be enhanced with nano-service characteristics such as multi-tenant security. The datacenter of the embodiments will be able to support new types of workloads (e.g., future nano-service based workloads implementing critical functions, e.g., Internet of Things (IoT) applications, network function virtualization (NFV) applications and similar processes).

The embodiments will be able to save on IaaS resources consumption (i.e., avoiding the overcommitting of central processing unit (CPU) and memory with an order of magnitude for Unikernels units of execution compared to VMs units of execution). The embodiments dispense with all the overhead from the management of VMs running all the components consolidated in VMs. This bypasses a manual, slow, and very coarse scaling with all the redundant userspace+kernelspace software that could be reduced to a bare minimum services/management of nano-services (Unikernels) running directly on bare metal IaaS and scaling with the fine granularity of slim unikernels.

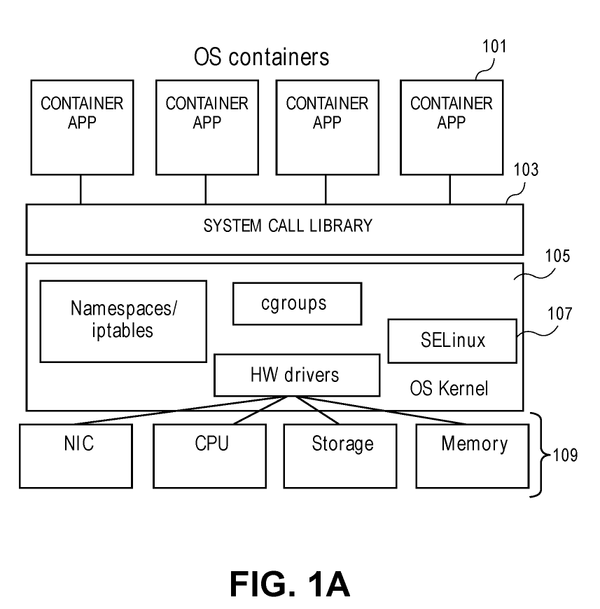

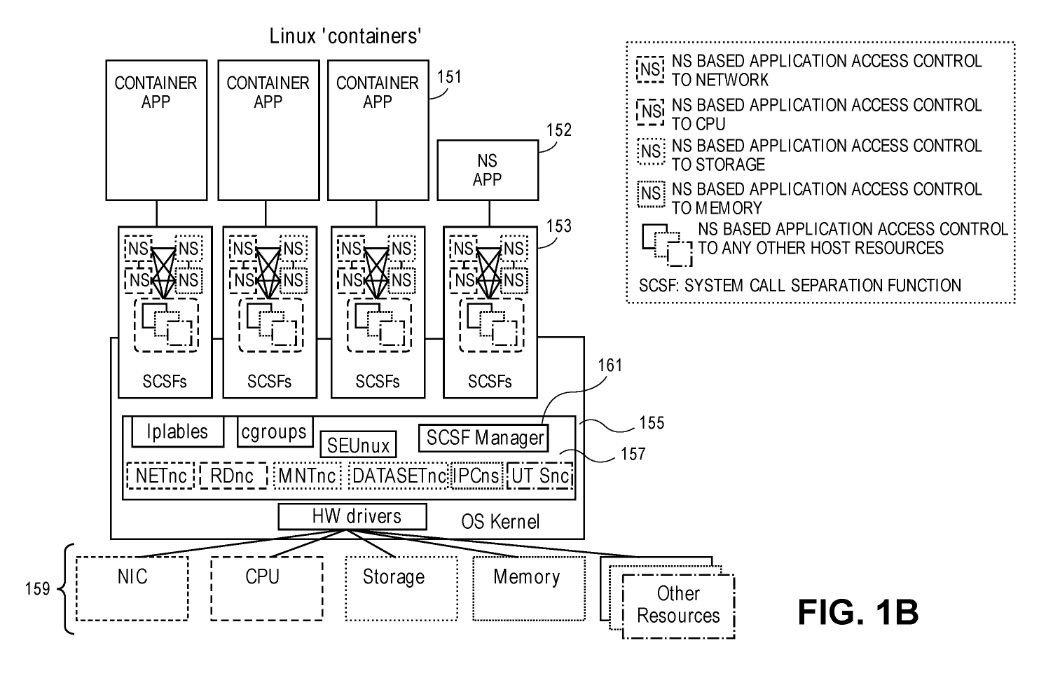

FIG. 1A is a diagram of one embodiment of a datacenter configuration. In this datacenter configuration multi-tenancy is supported using containers 101 or virtual machines or similar self-contained operating environments where the containers 101 are controlled by a specific tenant of the datacenter to run application over the hardware 109 of the datacenter. Any number and variety of application and tenants can be supported via the set of containers 101 that can have any size, configuration and access arrangement with the hardware resources 109.

The containers 101 access the hardware resources 109 via a shared system call library 103 and a set of supporting components 107 in the operating system 105 or hypervisor. The shared system call library 103 is a set of functions that provide a set of ‘hooks’ for accessing the hardware resources as managed by the operating system 105. The operating system 105 services the system calls via one of the supporting components 107 of the operating system. The system call library can have any number of functions and configuration of functionality that supports the access to the resources of the datacenter 109 as managed by the operating system 105, which may police or enforce policies on access to these shared hardware resources 109.

The operating system 105 can be any type of operating system and can be a hypervisor and a set of operating systems running on the hypervisor. Any configuration of operating systems and hypervisors may coordinate to manage the computing hardware resources 109. The components can include drivers, memory management systems, network management systems and similar components that may be aligned with the underlying hardware resources of the system. The underlying hardware resources 109 can include network interface cards (NICs), central processing units (CPUs), application specific integrated circuits (ASICs), dynamic and static memory, storage systems (e.g., magnetic, optical, solid state or similar storage systems), and similar datacenter hardware resources. The storage systems can be non-transitory computer-readable media. The storage system can store the instructions and code to enable implementation of the processes described herein. The hardware resources can execute these instructions to effect the processes and structures described herein.

FIG. 1B is a diagram of one embodiment of a datacenter configuration with system call separation functions (SCSFs). In this embodiment, the shared system call library has been replaced with a set of nano-service implemented system call separation functions that are specific to an associated container or virtual machine applications 151 and further support nano-service applications 152. Thus, the shared system call library no longer provides an attack surface where multi-tenancy isolation may be attached as each SCSF is tied to a single container application 151 or nano-service application 152.

Further, the set of SCSFs 153 that are initiated for each container application 151 or nano-service application 152 are specific to that application and unnecessary functions are not generated. For example, if a given container application does not make use of a particular hardware resource, then the associated SCSF for that hardware resource can be omitted from the set of SCSFs instantiated for that container application. If any of the SCSFs fails or is overloaded, then it does not directly affect the other nano-services of the container application or nano-service or those other tenants.

The operating system 155 can include modules that interface with the SCSFs to manage the associated hardware resource 159 access. These operating system 155 components 157 can correspond to specific hardware resources 159. The SCSFs 153 receive resource requests from the container applications 151 and nano-service applications 153 and in turn generate a query to the operating system 155 or more specifically to the operating system component 157 responsible for managing the requested resource. Once the resource provides or services the request, return information or data may be provided to the requesting SCSF 153 that in turn provides it to the requesting container application 151 or nano-service application 152.

Thus, the embodiments provide the same hardware resource management functionality, but running in even more lightweight nano-service that are used to manage all tenants' containers and tenants nano-services. The embodiments provide a reduction in the overhead of dedicating redundant infrastructure resources to each unique tenant container application.

During runtime, the SCSFs intercept system calls from the container applications 151 and nano-service applications 152 and based on preconfigured policy determined at SCSF deployment time, the SCSF determines if a particular container application 151 or nano-service application 153 is allowed to execute the system call or not. The difference compared to prior implementations is that the SCSF are immutable and secure and cannot be tampered with even with remote functions (vs. local host functions) running distributed all over the datacenter using distributed stateful firewall filters.

In some embodiments, the processes described herein with relation to the build time creation of the SCSFs may be implemented via an SCSF manager 161. These functions may be in a single component or distributed over multiple components depending on the implementation. Example, implementations are further described herein below. One skilled in the art would appreciate that the functions of the SCSF manager 161 to build and instantiate the SCSF for any given container or nano-service application can be grouped into any combination and distribution of components.

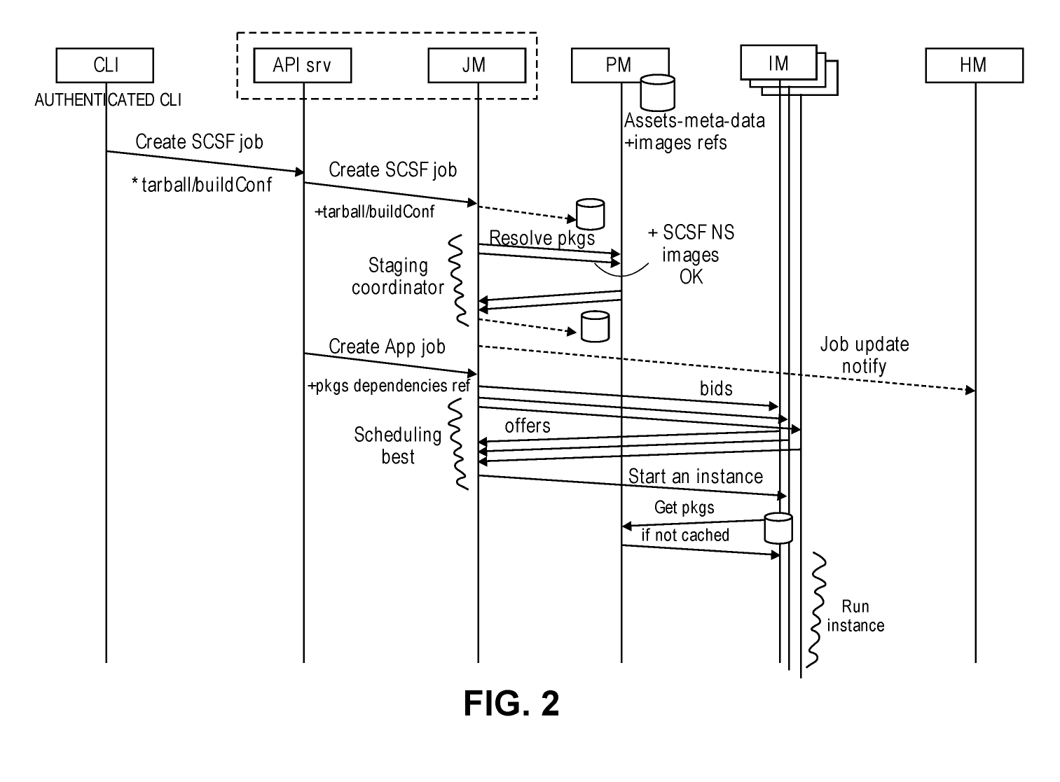

FIG. 2 is a diagram of one embodiment of a timing diagram of the process for deploying SCSFs. When a virtualized application is deployed, for example a container application or nano-service application, at least one SCSF nano-service is deployed to handle the system calls. The nano-service is configured with a set of policies to be applied to a particular set of defined system calls associated with that SCSF. A single nano-service could also control the system call access to more than one physical host resources. Moreover, a sequence of access control calls from SCSFs could be needed for example in the case where the storage access may also require access to a network (NIC). The mesh between the SCSFs depicted in FIG. 1B is such a set of relations. The logical mesh configuration may be a shared memory function or similar implementation.

Also, each container or nano-service application can be bound to only one immutable SCSF (e.g., of type <color n> (FIG. 1)) that is, instantiated from a distributed image repository trusted with a notary service architecture for instance. To further secure the SCSFs, the embodiments may use trusted computing environments to make it inaccessible even from the host.

The process shown in the timing diagram of FIG. 2 is provided by way of example and not limitation. The process for initiating a container application or nano-service application can be carried out at a command line interface (CLI) that may authenticate a request to start an application. In tandem with the creation of the application, the CLI can generate a job to create at least one SCSF to service the application. The CLI sends a request to the API server (API srv), which packages the source code for the application and/or the associated SCSFs in a package such as a tarball and uploads it to the datacenter to be executed. In some embodiments, the datacenter infrastructure is augmented to identify and package the SCSFs that are need for any given application to be instantiated. For example, a tarball may include the pre-defined nano-services and the build configuration describing the logical resources requirements (services, runtimes, packages dependencies) of the application on the host as well as the staging workflow process to build and deploy the container or nano-service application along with its required SCSF. In the example, the API server invokes the staging coordinator job to ingest the source code along with any dependent packages through package resolution. The dependent packages could include the NS pre-defined SCSFs including its staging workflow and similar information.

In some embodiments, a job manager receives the request and the detected or specified staging pipeline is invoked and stager(s) compile or build the source code and push it to the package manager (PM), which stores the assets and metadata as a “Package.” The API server may send the expected initial state of the application to the job manager (JM), including the package and package dependency information. The JM broadcasts a network address translation security (NATS) message to all instance managers (IMs) requesting bids for an IM to start one or more job instances (containers). Each IM responds according to its taint with an offer to start an instance of the job. Each IM's taint is determined by a set of scoring rules based on the set of nodes (containers) under its control, tags asserted on the job definition, and other criteria. The JM receives the bids and sends a request to the “best” scoring IM to start an instance of the app. IM retrieves the relevant packages from its local cache, or from the PM if it is an initial deploy, and starts the appropriate number of instances. Each IM will start no more than one instance per node (container).

This implementation is provided by way of example and not limitation. Those skilled in the art would understand that the creation of container and nano-service applications along with the associated SCSFs can be implemented similarly dependent on the architecture of the datacenter. Other datacenter architectures may organize the functions into different components and configurations. The example of FIG. 2 describes the build time functions for creating SCSFs for a given application as being bundled with or implemented in coordination with the application instantiation by the same components. The sub-functions related to the build time handling of the SCSF for the application is referred to herein as the SCSF manager, which may have functions that span the CLI, API server and JM in some architectures.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

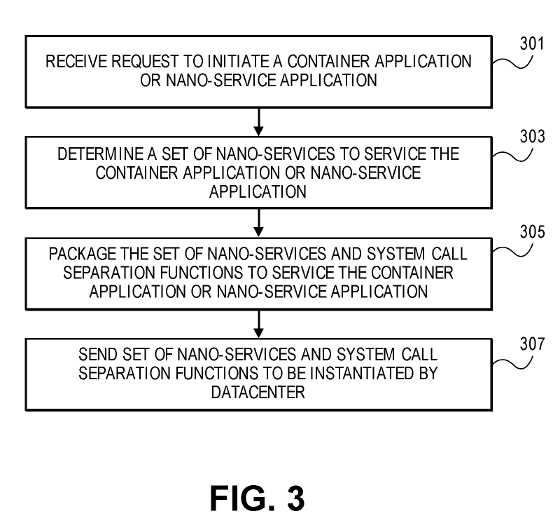

FIG. 3 is a flowchart of one embodiment of a build time process for SCSFs. The processes are described with a broad applicability to any type of datacenter architecture where multi-tenancy is supported with applications running in containers or nano-services specific to a tenant. The process of FIG. 3 sets forth the processes for building the SCSFs to support an application that has been instantiated for a given tenant. The process begins with the SCSF manager or similar component receiving a request to initiate a container application or nano-service application (Block 301). In response to receiving the request, the set of nano-services encompass SCSFs or similar functions that are determined to be associated with the application to be initiated in order to service that application (Bock 303). The process may use an established mapping or characteristics of the application to determine the nano-services and/or SCSFs that are to be instantiated with the application.

Once the set of nano-services and SCSFS to be instantiated with the application is determined, then the set of nano-services including the SCSFs is packaged together and in some embodiments with the application to be instantiated (Block 305). The set of nano-services and SCSFs are then forwarded to be instantiated in the data center (Block 307). In some embodiments, the instantiation is also carried out by the same process or components. In other embodiments, the instantiation of the application and/or the nano-services with SCSFs is separately implemented.

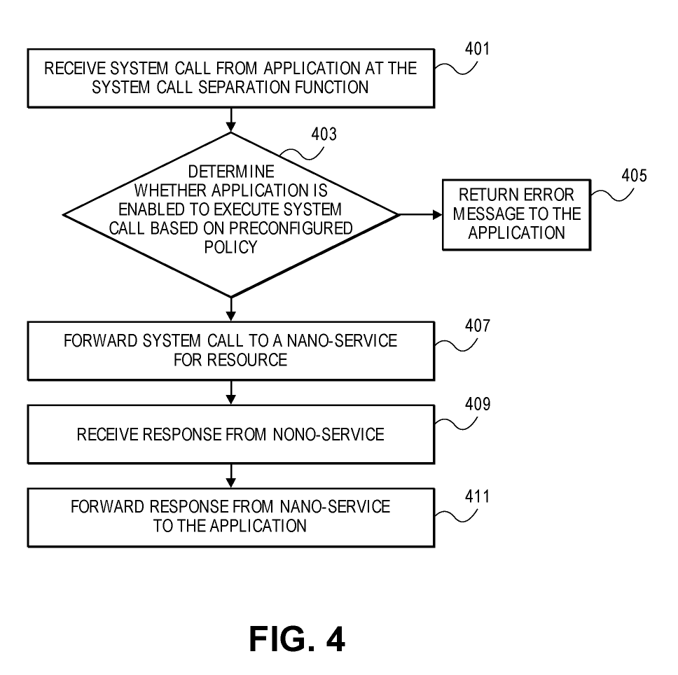

FIG. 4 is a flowchart of one embodiment of a run-time process for SCSFs. After the nano-services and the SCSFs have been instantiated with the associated application, the nano-services (and the SCSFs) may be immutable. This provides security from malicious configuration or modification after the nano-services and SCSFs are running. The nano-services and the SCSFs react to system calls from the application with which they are associated (Block 401). When a system call is intercepted by the SCSF, then a determination is made whether the application that issued the system call is enabled to execute the system call based on preconfigured policies for the application and the system call type (Block 403). If the application is not enabled for the system call, then an error message may be returned to the requesting application (Block 405).

However, if the application is enabled for the system call, then the SCSF may forward the system call to the associated nano-service for the resource(s) associated with the system call (Block 407). When a response is received from the nano-service for the resource (Block 409), then the SCSF can return the response to the requesting application (Block 411).

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by a datacenter to improve multi-tenant security by isolating container applications or nano-service applications by implementing a set of system call separation functions (SCSFs) in a set of corresponding nano-services for each container application or nano-service application, the method comprising:
receiving a request to initiate a container application or a nano-service application;
determining a set of nano-services and SCSFs to service the container application or the nano-service application;
packaging the set of nano-services and SCSFs to service the container application or the nano-service application; and
sending the set of nano-services and SCSFs to be instantiated by the datacenter.

2. The method of claim 1, wherein the set of SCSFs are configured to intercept system calls from the container application or nano-service application.

3. The method of claim 1, wherein the set of nano-services and SCSFs are packaged with the container application or the nano-services application.

4. The method of claim 1, wherein the datacenter executes at least one SCSF, the method further comprising:
receiving a system call from the container application or nano-services at the at least one SCSF; and
determining whether the container application or nano-services application is enabled to execute the system call based on a preconfigured policy.

5. The method of claim 4, further comprising:
returning an error message to the container application or the nano-service application in response to determining that the container application or the nano-service application is not enabled for the system call.

6. The method of claim 4, further comprising:
forwarding the system call to a nano-service for a resource;
receiving a response from the nano-service for the resource; and
forwarding the response to the container application or the nano-service application.

7. A datacenter to execute a method to improve multi-tenant security by isolating container applications or nano-service applications by implementing a set of system call separation functions (SCSFs) in a set of corresponding nano-services for each container application or nano-service application, the datacenter comprising:
a non-transitory computer readable medium having stored therein a SCSF manager; and
a processor configured to execute the SCSF manager, the SCSF manager to receive a request to initiate a container application or a nano-service application, to determine a set of nano-services and SCSFs to service the container application or the nano-service application, to package the set of nano-services and SCSFs to service the container application or the nano-service application, and to send the set of nano-services and SCSFs to be instantiated by the datacenter.

8. The datacenter of claim 7, wherein the set of SCSFs are configured to intercept system calls from the container application or nano-service application.

9. The datacenter of claim 7, wherein the set of nano-services and SCSFs are packaged with the container application or the nano-services application.

10. The datacenter of claim 7, wherein at least one SCSF is configured to receive a system call from the container application or the nano-services application at the at least one SCSF, and to determine whether the container application or nano-services application is enabled to execute the system call based on a preconfigured policy.

11. The datacenter of claim 10, wherein the at least one SCSF is further configured to return an error message to the container application or the nano-service application in response to determining that the container application or the nano-service application is not enabled for the system call.

12. The datacenter of claim 10, wherein the at least one SCSF is further configured to forward the system call to a nano-service for a resource, receiving a response from the nano-service for the resource, and to forward the response to the container application or the nano-service application.

13. A non-transitory computer-readable medium having stored therein a set of instructions which when executed by a computing device cause the computing device to perform a method to improve multi-tenant security by isolating container applications or nano-service applications by implementing a set of system call separation functions (SCSFs) in a set of corresponding nano-services for each container application or nano-service application, the computing device when configured to execute the set of instructions is caused to perform the operations of:
receiving a request to initiate a container application or a nano-service application;
determine a set of nano-services and SCSFs to service the container application or the nano-service application;
packaging the set of nano-services and SCSFs to service the container application or the nano-service application; and
sending the set of nano-services and SCSFs to be instantiated by a datacenter.

14. The non-transitory computer-readable medium of claim 13, wherein the set of SCSFs are configured to intercept system calls from the container application or nano-service application.

15. The non-transitory computer-readable medium of claim 13, wherein the set of nano-services and SCSFs are packaged with the container application or the nano-services application.

16. The non-transitory computer-readable medium of claim 13, having further instructions stored therein to execute at least one SCSF, causing the computing device to:
receiving a system call from the container application or the nano-services application at the at least one SCSF; and
determining whether the container application or nano-services application is enabled to execute the system call based on a preconfigured policy.

17. The non-transitory computer-readable medium of claim 16, having further instructions stored therein to execute at least one SCSF, causing the computing device to:
returning an error message to the container application or the nano-service application in response to determining that the container application or the nano-service application is not enabled for the system call.

18. The non-transitory computer-readable medium of claim 16, having further instructions stored therein to execute at least one SCSF, causing the computing device to:
forwarding the system call to a nano-service for a resource;
receiving a response from the nano-service for the resource; and
forwarding the response to the container application or the nano-service application.
